(19) United States
(12) Patent Application Publication
(10) Pub. No.: US 2018/0015397 A1
(43) Pub. Date: Jan. 18, 2018

(54) WATER PURIFYING FILTER AND REFRIGERATOR HAVING THE SAME

(71) Applicant: SAMSUNG ELECTRONICS CO., LTD., Suwon-si (KR)

(72) Inventors: Sang Min PARK, Suwon-si (KR); Jae Koog AN, Gwangju (KR)

(73) Assignee: SAMSUNG ELECTRONICS CO., LTD., Suwon-si (KR)

(21) Appl. No.: 15/333,741

(22) Filed: Oct. 25, 2016

(30) Foreign Application Priority Data
Jul. 13, 2016 (KR) 10-2016-0088669

(51) Int. Cl. B01D 35/02; F25D 23/06; F25D 23/12; B01D 35/30; C02F 1/00

(52) U.S. Cl. CPC B01D 35/02; B01D 35/30; C02F 1/003; F25D 23/126; F25D 23/069; B01D 2201/302; C02F 2201/004; C02F 2201/005; C02F 2307/12; F25D 2323/121; C02F 2307/10

(57) ABSTRACT

A water purifying filter for a refrigerator includes a filter, an inner housing to accommodate the filter therein and an outer housing to accommodate the inner housing therein. An outer surface of the inner housing and an inner surface of the outer housing are spaced apart from each other to form an insulation space.

### CROSS-REFERENCE TO RELATED APPLICATIONS

This application claims the priority benefit of Korean Patent Application No. 10-2016-0088669, filed on Jul. 13, 2016 in the Korean Intellectual Property Office, the disclosure of which is incorporated herein by reference in its entirety.

### BACKGROUND

### 1. Field

Embodiments of the disclosure relate to a water purifying filter for removing foreign substances contained in water, and a refrigerator having the same.

### 2. Description of the Related Art

Recently, refrigerators including a dispenser which supplies water or an ice machine which automatically makes ice have been developed.

A refrigerator including a dispenser or an ice machine may include a water supply device which supplies water to be used in the dispenser or the ice machine.

In the refrigerator including the water supply device as described above, a water purifying filter is included to remove foreign substances contained in water supplied from an external water source and supply the water to the dispenser or the ice machine.

The water purifying filter includes therein a filter, e.g., carbon black, which is capable of adsorbing foreign substances thereonto. Thus, foreign substances removed from water are accumulated onto the filter as the water purifying filter is used.

Thus, the water purifying filter may be installed to be detachable from the refrigerator so that it may be separated from the refrigerator after a period of use and a new water purifying filter may be installed and used in the refrigerator.

### SUMMARY

Therefore, it is an aspect of the disclosure to provide a water purifying filter capable of reducing the formation of ice thereon and a refrigerator having the same.

It is another aspect of the disclosure to provide a water purifying filter capable of preventing from being damaged by external shocks and reducing water leakage caused by damage thereto, and a refrigerator having the same.

It is another aspect of the disclosure to provide a refrigerator in which a water purifying filter is more stably coupled to a connection valve.

Additional aspects of the disclosure will be set forth in part in the description which follows and, in part, will be apparent from the description, or may be learned by practice of the disclosure.

In accordance with an aspect of the disclosure a water purifying filter may include a filter, an inner housing to accommodate the filter therein, and an outer housing to accommodate the inner housing therein. An outer surface of the inner housing and an inner surface of the outer housing are spaced apart from each other to form an insulation space.

The insulation space may be maintained in a vacuum state.

The water purifying filter may further include an insulator to fill the insulation space.

The inner housing may be formed in a hollow cylindrical shape, and the outer housing may be formed in a hollow square container shape.

One side of the inner housing and one side of the outer housing may be open, and the water purifying filter further may include a connection cap to cover openings in the inner housing and the outer housing.

The connection cap may include a cap portion to cover the openings in the inner housing and the outer housing, an inner fixed portion which extends in a circular ring form from the cap portion and on which the open side of the inner housing is fixed and an outer fixed portion which extends in a square ring form from the cap portion and on which the open side of the outer housing is fixed.

In accordance with an aspect of the disclosure a refrigerator may include a main body and a water purifying filter formed in a square container shape and installed on the main body to be detachable from the main body. The main body may include an installation hole which is formed in a square shape and in which the water purifying filter is installed and a connection valve which is provided in the installation hole and to which the water purifying filter is coupled, and the water purifying filter is coupled to the connection valve while being rotated.

The water purifying filter may include an outer housing forming an exterior of the water purifying filter, the outer housing may include a body portion having a square container shape, a lid portion formed in a square shape at a side of the body portion and configured to cover the installation hole and a rotary guide portion formed between the body portion and the lid portion to have a round cross-section such that the water purifying filter is rotatable.

The outer housing may further include a knob portion provided on the lid portion.

The water purifying filter may further include a filter and an inner housing configured to accommodate the filter and accommodated in the outer housing.

An outer surface of the inner housing and an inner surface of the outer housing may be spaced apart from each other to form an insulation space.

The water purifying filter may further include a connection cap configured to cover one side of the outer housing and coupled to the connection valve. The connection cap may include coupling hooks coupled to the connection valve and the connection valve is formed in a cylindrical shape, one side of which is open, and may include coupling projections which are provided on an inner circumferential surface thereof and to which the coupling hooks are stopped by being rotated.

The refrigerator may further include an installation guide device provided in the installation hole and configured to guide the water purifying filter inserted into the installation hole and the connection valve to be coupled to each other.

The installation guide device may include a pressure lever to pressurize downward the water purifying filter inserted into the installation hole and at least one guide member provided below the water purifying filter to support corners of the outer housing.

The pressure lever may include a fixed portion fixed to the main body, a pressurizing portion protruding in an insertion path of the water purifying filter and an elastic portion provided between the fixed portion and the pressurizing portion to apply an elastic force.

The at least one guide member may include a pair of guide members spaced apart from each other in a horizontal direction.

The pair of guide members may include a guide plane formed in a curved shape and configured to guide movement and rotation of the water purifying filter.

The guide plane may have a radius of curvature corresponding to half a diagonal length of the outer housing.

The corners of the outer housing may be curved.

The installation guide device may further include a stopping member provided between the pair of guide members, the stopping member may include a stopping projection to stop a front end of a water purifying filter which is less than a lower specification limit and moved downward by the pressure lever.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a front view of a refrigerator according to an embodiment of the disclosure;

FIG. 2 is a perspective view to show an installing of the water purifying filter;

FIG. 3 is a cross-sectional view of the water purifying filter and an installation guide device;

FIG. 4 is a perspective view of the water purifying filter;

FIG. 5 is a cross-sectional view of the water purifying filter;

FIG. 6 is a cross-sectional view of the installation guide device;

FIGS. 7 to 9 are cross-sectional views to show installing steps of the water purifying filter.

### DETAILED DESCRIPTION

Reference will now be made in detail to embodiments, the examples of which are illustrated in the accompanying drawings, wherein like reference numerals refer to like elements throughout. The embodiments are described below to explain the disclosure by referring to the figures.

A refrigerator in accordance with an embodiment of the disclosure will now be described in detail with reference to the accompanying drawings.

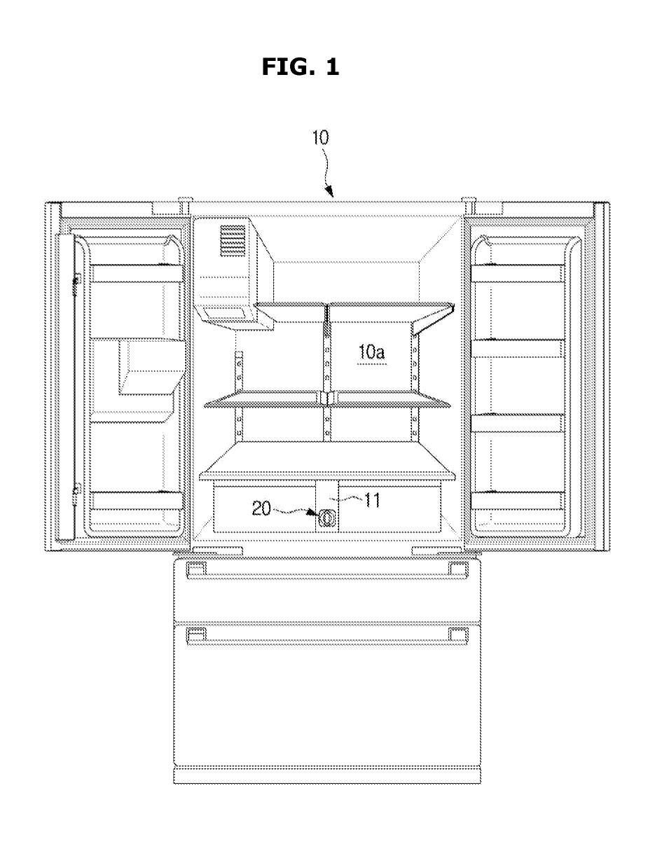

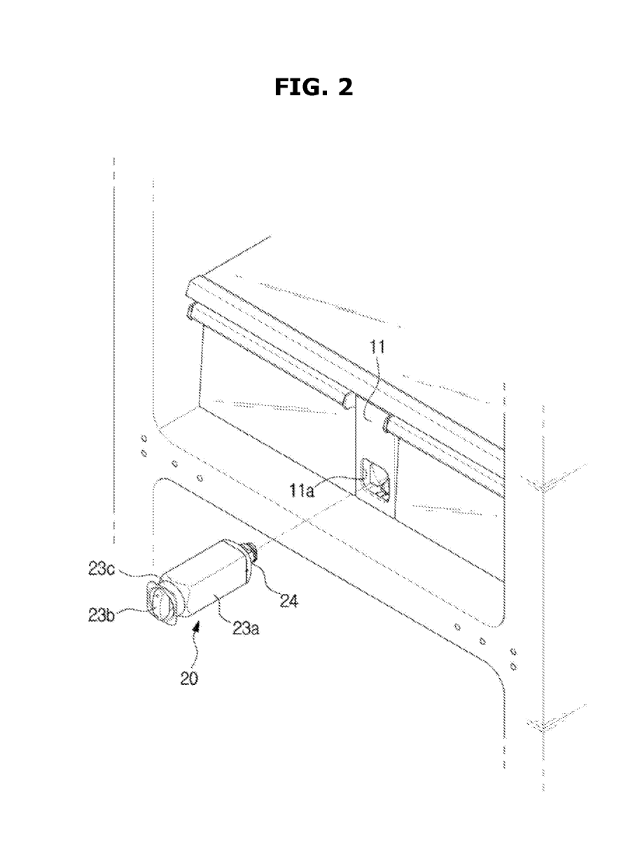

As illustrated in FIGS. 1 and 2, a water purifying filter 20 in accordance with an embodiment of the disclosure may be installed in a main body 10 of a refrigerator to filter water to be supplied to a dispenser (not shown) or an ice machine (not shown) of the main body 10 so that foreign substances contained in the water may be removed.

In the embodiment, the water purifying filter 20 is installed on a partition 11 which divides an inner space of a storage chamber 10a to be detachable from the partition 11. Thus, when the water purifying filter 20 malfunctions after use thereof, the water purifying filter 20 may be separated from the main body 10 and a new water purifying filter 20 may be installed and used in the main body 10.

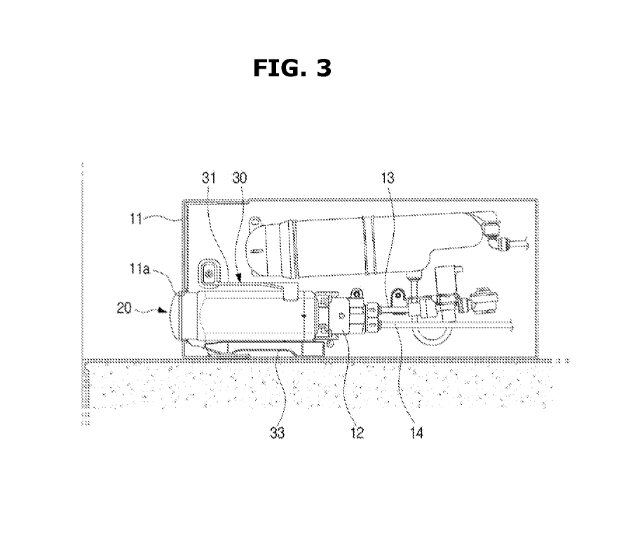

As illustrated in FIG. 3, the main body 10 may include an installation hole 11a which is provided in the partition 11 and in which the water purifying filter 20 is installed, and a connection valve 12 provided in the installation hole 11a and connected to the water purifying filter 20 inserted into the installation hole 11a. In the embodiment, the water purifying filter 20 is coupled to the connection valve 12 by being rotated in a state in which it is inserted into the installation hole 11a.

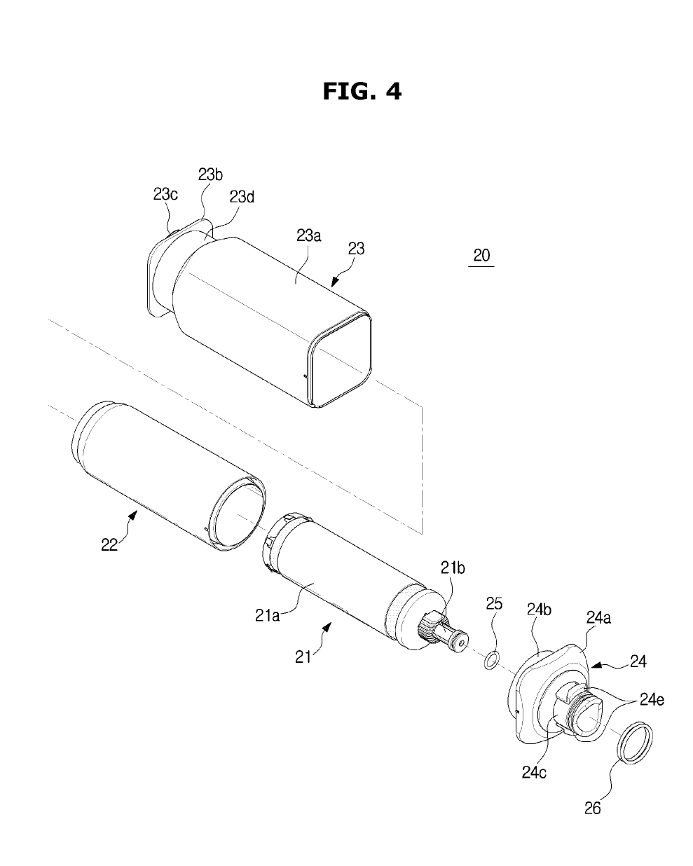

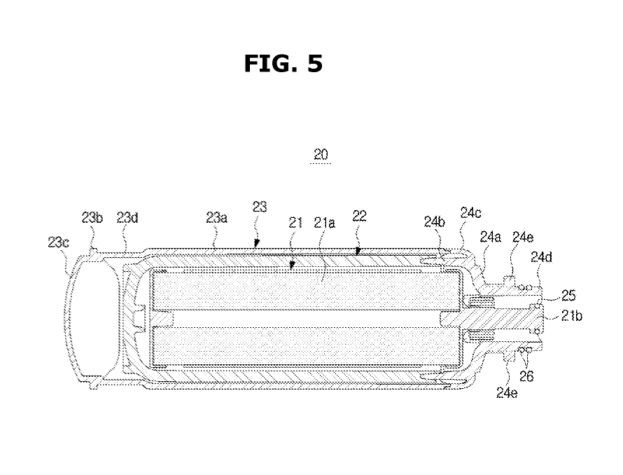

As illustrated in FIGS. 4 and 5, the water purifying filter 20 may include a filter 21 which removes foreign substances contained in water, an inner housing 22 in which the filter 21 is accommodated, an outer housing 23 in which the inner housing 22 is accommodated, and a connection cap 24 covering one side of each of the inner housing 22 and the outer housing 23 and connected to the connection valve 12 inside the installation hole 11a during the installation of the water purifying filter 20 in the installation hole 11a.

The filter 21 may include an adsorption unit 21a formed of carbon black which adsorbs foreign substances contained in water, and a connection pipe 21b provided at a side of the adsorption unit 21a and connected to the connection valve 12. A sealing member 25 having an O-ring form is installed on an outer circumferential surface of the connection pipe 21b to perform sealing.

The inner housing 22 has a hollow cylindrical shape, one side of which is open and another side of which is closed, in which the filter 21 is accommodated. That is, since the inner housing 22 has a round cross-section, water pressure is not concentrated on a specific portion of the inner housing 22 and is uniformly distributed to an inner side of the inner housing 22 even when the water pressure is applied into the inner housing 22. Thus, the inner housing 22 having the cylindrical shape may have high pressure resistance.

The outer housing 23 forms the exterior of the water purifying filter 20, and has a substantially hollow square container shape, one side of which is open and another side of which is closed, in which the inner housing 22 is accommodated.

In this case, an outer surface of the inner housing 22 and an inner surface of the outer housing 23 are spaced apart from each other to form an insulation space between the inner housing 22 and the outer housing 23, in which movement of heat decreases.

Thus, chilly air which is to be delivered to the filter 21 inside the water purifying filter 20 may be decreased through the insulation space between the inner housing 22 and the outer housing 23. Thus, the formation of ice on the filter 21 due to the chilly air may decrease. Even if the inner housing 22 or the outer housing 23 is damaged by an external shock, water leakage may be prevented from occurring in the outside of the water purifying filter 20.

Furthermore, since the water purifying filter 20 has a dual structure including the inner housing 22 and the outer housing 23 as described above, the water purifying filter 20 may have high pressure resistance owing to the inner housing 22, and the outer housing 23 may be formed in various shapes, including the square container shape as in the embodiment.

The outer housing 23 may include a body portion 23a configured to accommodate the inner housing 22, a lid portion 23b provided at a side of the body portion 23a to cover the installation hole 11a, and a knob portion 23c which is provided on the lid portion 23b and through which a user may grasp the water purifying filter 20 to apply a force to the water purifying filter 20. In the embodiment, each of the body portion 23a and the lid portion 23b is formed in a square shape corresponding to the installation hole 11a.

As described above, the installation hole 11a, the body portion 23a, and the lid portion 23b are each formed in a substantially square shape. Thus, when the body portion 23a and the lid portion 23b of the outer housing 23 are placed on a location corresponding to the installation hole 11a, a user cannot rotate the water purifying filter 20.

However, since the water purifying filter 20 is coupled to the connection valve 12 while being rotated as described above, a rotary guide portion 23d having a round cross-section is formed between the body portion 23a and the lid portion 23b to rotate the water purifying filter 20.

Thus, when the rotary guide portion 23d is placed on the location corresponding to the installation hole 11a by inserting the water purifying filter 20 into the installation hole 11a, a user may apply a force to the water purifying filter 20 through the knob portion 23c to rotate the water purifying filter 20.

The connection cap 24 may include a cap portion 24a configured to cover openings formed in a side of the inner housing 22 and a side of the outer housing 23, an inner fixed portion 24b extending in a circular ring form from the cap portion 24a and fixed on a side of the inner housing 22, and an outer fixed portion 24c extending in a substantially square ring form from the cap portion 24a and fixed on a side of the outer housing 23. The inner housing 22 has a cylindrical shape and is thus fixed on the inner fixed portion 24b by a spin fusion technique. The outer housing 23 is fixed on the outer fixed portion 24c by a welding technique such as spot welding.

The water purifying filter 20 is coupled to the connection valve 12 through the connection cap 24. To be coupled to the connection valve 12, the connection cap 24 may include a connection portion 24d extending from a central portion of the cap portion 24a and coupled to the connection valve 12 to receive water from the connection valve 12, and coupling hooks 24e which are integrally protruding from portions of the connection cap 24 adjacent to the connection portion 24d and through which the water purifying filter 20 is coupled to the connection valve 12. In the embodiment, two coupling hooks 24e are spaced apart from each other in a circumferential direction.

Sealing members 26 each having an O-ring form are formed at an outer side of the connection portion 24d to prevent water leakage from occurring in a state in which the connection portion 24d is coupled to the connection valve 12.

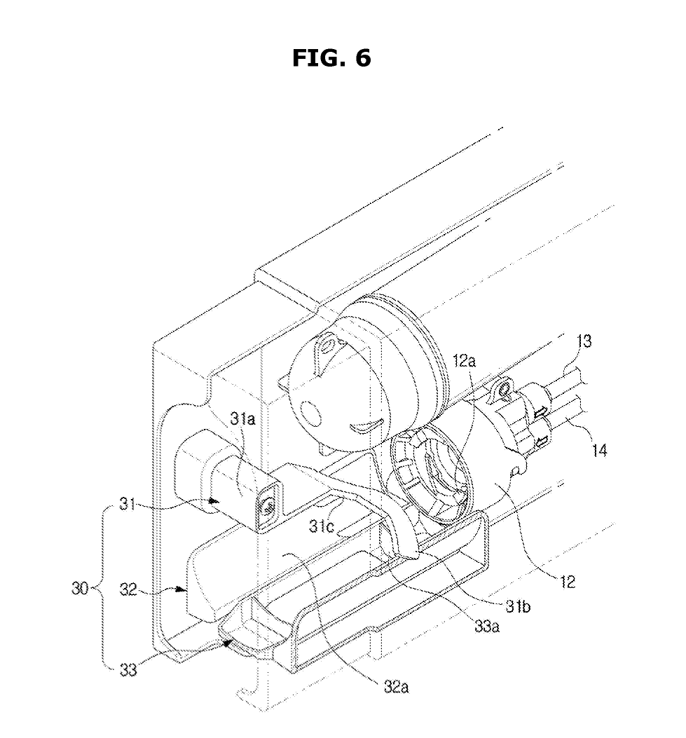

As illustrated in FIG. 6, the connection valve 12 is formed in a cylindrical shape having an open side such that the connection portion 24d is accommodated therein. Coupling projections 12a are provided on an inner circumferential surface of the connection portion 24d, to which the coupling hooks 24e described above are coupled by being rotated. In the embodiment, the connection valve 12 may include two coupling projections 12a spaced apart from each other in the circumferential direction to correspond to two coupling hooks 24e provided on the water purifying filter 20.

In the embodiment, the coupling projections 12a extend by a certain length in the circumferential direction to be tilted in the circumferential direction. Thus, when the water purifying filter 20 is rotated, the coupling hooks 24e are moved along the coupling projections 12a and thus the water purifying filter 20 is moved in a direction in which the water purifying filter 20 is inserted into the installation hole 11a. A water supply pipe 13 which supplies water which is to be filtered to the connection valve 12 and a drain pipe 14 which supplies water filtered by passing through the filter 21 of the water purifying filter 20 to a dispenser (not shown) or an ice machine (not shown) are connected to the connection valve 12.

The main body 10 further may include an installation guide device 30 provided in the installation hole 11a and configured to guide the water purifying filter 20 inserted through the installation hole 11a to be stably coupled to the connection valve 12. The installation guide device 30 causes the water purifying filter 20 to be exactly coupled to the connection valve 12, and permits only the water purifying filter 20 meeting standard specifications to be coupled to the connection valve 12 and prevents a water purifying filter which does not meet the standard specifications from being coupled to the connection valve 12.

The installation guide device 30 may include a pressure lever 31 configured to pressurize downward the water purifying filter 20 inserted through the installation hole 11a, and guide members 32 supporting the water purifying filter 20. In the embodiment, the outer housing 23 has curved corners such that the water purifying filter 20 is easily movable in the circumferential direction and along guide planes 32a which are to be described below.

The pressure lever 31 is provided above the water purifying filter 20 inserted into the installation hole 11a, and configured to pressurize the water purifying filter 20 downward so that the water purifying filter 20 may be moved while being supported by the guide members 32.

In the embodiment, the pressure lever 31 is provided in the form of a leaf spring installed such that one end thereof is fixedly installed in the main body 10 and another end thereof protrudes in an insertion path of the water purifying filter 20. To this end, the pressure lever 31 may include a fixed portion 31a fixed in the main body 10, a pressurizing portion 31b protruding in the insertion path of the water purifying filter 20 inserted into the installation hole 11a to apply a force on the water purifying filter 20 downward, and an elastic portion 31c provided between the fixed portion 31a and the pressurizing portion 31b to apply an elastic force.

The pressurizing portion 31b is tilted in the insertion path of the water purifying filter 20 to be gradually moved upward by movement of the water purifying filter 20, and is formed in a roughly U shape to correspond to an upper portion of the water purifying filter 20.

The elastic portion 31c is formed of a curved leaf spring to apply an elastic force.

The guide members 32 respectively include the guide planes 32a supporting an outer side of the water purifying filter 20 inserted into the installation hole 11a, i.e., a lower portion of the outer housing 23. The guide planes 32a are each formed in an arc shape to guide rotation of the water purifying filter 20. As described above, since the outer housing 23 has a square shape, the guide planes 32a each have a radius of curvature corresponding to half a diagonal length of the outer housing 23. Thus, the water purifying filter 20 may be inserted and rotated in the installation hole 11a in a state in which the corners of the outer housing 23 are supported by the guide planes 32a.

Furthermore, in the embodiment, two guide members 32 are provided. The two guide members 32 are spaced apart from each other in a horizontal direction, so that when a water purifying filter which is less than a lower specification limit is installed through the installation hole 11a, a front end of the water purifying filter may fall downward via a space between the two guide members 32. That is, a water purifying filter which is less than the lower specification limit is not supported by the guide planes 32a and thus a front end thereof is pushed downward by the pressure lever 31 described above. Thus, the water purifying filter falls into the space between the two guide members 32.

A stopping member 33 is provided between the two guide members 32 to prevent a water purifying filter which does not meet the standard specifications from being moved to the connection valve 12. In the embodiment, the stopping member 33 may include a stopping projection 33a protruding from a top surface thereof, so that when a water purifying filter which does not meet the standard specifications is inserted into the installation hole 11a and is then moved downward by the pressure lever 31, a front end of the water purifying filter is stopped by the stopping projection 33a.

A process of installing the water purifying filter 20 configured as described above in the installation hole 11a of the main body 10 will be described in more detail below.

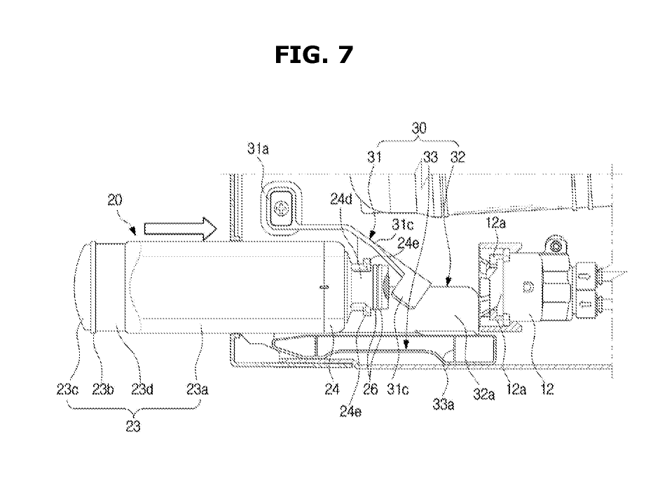

First, when the water purifying filter 20 is inserted into the installation hole 11a as illustrated in FIG. 7, the outer housing 23 having the square container shape of the water purifying filter 20 enters the installation hole 11a having the square shape along the installation hole 11a. In this case, the corners of the outer housing 23 entering the installation hole 11a are supported by the guide planes 32a and thus the water purifying filter 20 is inserted into the installation hole 11a while being moved linearly toward the connection valve 12.

When the water purifying filter 20 is inserted into the installation hole 11a to a certain degree or more, a front end of the water purifying filter 20 comes in contact with the pressurizing portion 31b of the pressure lever 31 protruding in the insertion path of the water purifying filter 20. Then, as the water purifying filter 20 is moved toward the connection valve 12, the elastic portion 31c is elastically deformed to move the pressurizing portion 31b upward and thus a force is applied to the water purifying filter 20 downward due to an elastic restoring force of the elastic portion 31c.

However, since the corners of the outer housing 23 of the water purifying filter 20 are supported by the guide planes 32a as described above, the force applied to the water purifying filter 20 by the pressurizing portion 31b of the pressure lever 31 maintains a state in which the corners of the outer housing 23 are supported by the guide planes 32a. Thus, the front end of the water purifying filter 20 is not moved downward and is directly linearly moved to the connection valve 12.

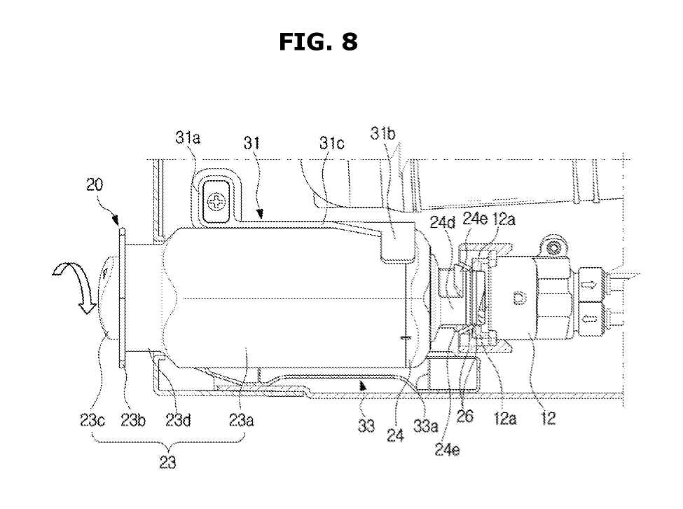

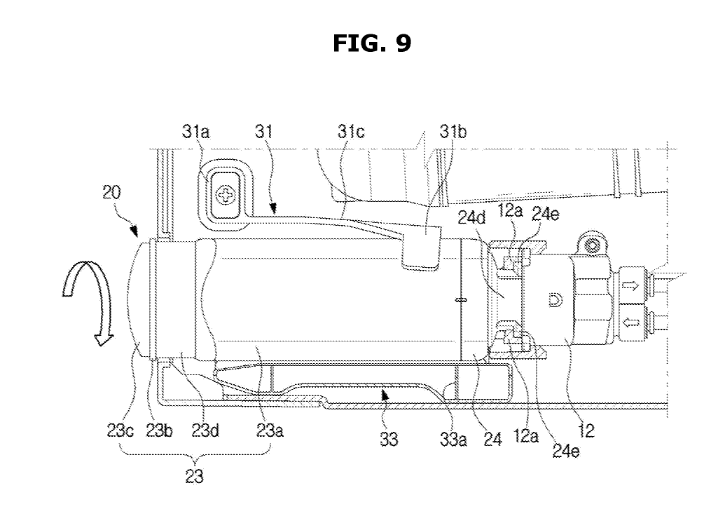

When the front end of the water purifying filter 20, i.e., the connection portion 24d, arrives at the connection valve 12 as illustrated in FIG. 8, the rotary guide portion 23d of the outer housing 23 is located on the location corresponding to the installation hole 11a. Since the water purifying filter 20 is rotatable in this state, when a user rotates the water purifying filter 20 through the knob portion 23c, the water purifying filter 20 is rotated as illustrated in FIG. 9 to couple the coupling hooks 24e of the connection cap 24 to the coupling projections 12a of the connection valve 12. Thus, the water purifying filter 20 is coupled to the connection valve 12. At the same time, as the water purifying filter 20 is moved inside the installation hole 11a, the installation hole 11a is covered with the lid portion 23b of the outer housing 23, thereby completing the installation of the water purifying filter 20.

Next, although not shown, a case in which a water purifying filter which does not meet the standard specifications is installed in a refrigerator will be described below.

When a water purifying filter which is greater than an upper specification limit is inserted into the installation hole 11a, the water purifying filter cannot pass through the installation hole 11a having the square shape.

A water purifying filter which is less in size than the installation hole 11a may pass through the installation hole 11a but is moved to the connection valve 12 in a state in which the water purifying filter is not supported by the guide planes 32a.

When the water purifying filter which is less than the lower specification limit is inserted into the installation hole 11a to a certain degree or more, a force is applied to a front end of the water purifying filter downward by the pressurizing portion 31b of the pressure lever 31 protruding in an insertion path of the water purifying filter. As described above, a water purifying filter which is less in size than the installation hole 11a is not supported by the guide planes 32a unlike the water purifying filter 20 which meets the standard specifications. Thus, the front end of the water purifying filter which is less than the lower specification limit cannot withstand the elastic restoring force of the elastic portion 31c and is thus moved downward by the pressure lever 31 while being tilted. As described above, the stopping member 33 is provided between the two guide members 32 and thus a front end of a water purifying filter which does not meet the standard specifications is stopped by the stopping projection 33a of the stopping member 33.

Thus, a water purifying filter which is greater than the upper specification limit cannot pass through the installation hole 11a having the square shape, and a front end of a water purifying filter which is less than the lower specification limit and may thus pass through the installation hole 11a is stopped by the stopping projection 33a of the stopping member 33. Thus, these water purifying filters which do not meet the standard specifications cannot arrive at the connection valve 12 and are thus prevented from being coupled to the connection valve 12.

In the embodiment, the outer housing 23 has the square container shape to prevent a water purifying filter which does not meet the standard specifications from being coupled to the connection valve 12 by the installation guide device 30. Alternatively, the outer housing 23 may be formed in a cylindrical shape similar to the inner housing 22, so that only an insulating performance of the water purifying filter 20 may be increased.

In the embodiment, the pressure lever 31 may include the elastic portion 31c formed of a leaf spring but is not limited thereto. Alternatively, one end of the pressure lever 31 may be installed to be rotatable in the refrigerator and the pressure lever 31 may be elastically supported by an additional elastic member such as a torsion spring.

Although the water purifying filter 20 is installed in the installation hole 11a of the partition 11 in the embodiment, embodiments of the disclosure are not limited thereto and the water purifying filter 20 may be installed on various locations, e.g., a rear surface, the bottom, etc. of the main body 10, to be detachable according to the design thereof.

In the embodiment, the insulation space between the inner housing 22 and the outer housing 23 is filled with air since an additional process is not performed thereon. However, embodiments of the disclosure are not limited thereto, and the insulation space may be maintained in a vacuum state to improve the insulating performance of the water purifying filter 20 so that the transfer of heat through conduction may not occur or may be filled with an insulator having high insulation performance such as foam resin to improve the insulating performance of the water purifying filter 20 using the insulation space.

In the embodiment, a pair of guide members 32 spaced apart from each other are provided to cause the guide members 32 to guide the water purifying filter 20 to the connection valve 12 and to prevent a water purifying filter which is less than the lower specification limit from being coupled to the connection valve 12.

Thus, only one guide member 32 may be provided in the installation hole 11a, so that the guide member 32 may perform only a function of guiding the water purifying filter 20 to the connection valve 12.

As is apparent from the above description, in a water purifying filter and a refrigerator in accordance with one or more embodiments of the disclosure, an insulation space may be formed between an inner housing and an outer housing to reduce the formation of ice on a filter.

In a water purifying filter and a refrigerator in accordance with one or more embodiments of the disclosure, even if an inner housing or an outer housing is damaged due to an external shock, water leakage does not occur, thereby reducing the occurrence of water leakage in the water purifying filter.

Furthermore, since a water purifying filter in accordance with one or more embodiments of the disclosure may include an inner housing and an outer housing, the water purifying filter may have high pressure resistance owing to the inner housing and the outer housing may be formed in various shapes, e.g., a square container shape.

In addition, in a refrigerator in accordance with one or more embodiments of the disclosure, an installation guide device may cause a water purifying filter which meets standard specifications to be guided and coupled to a connection valve and prevent a water purifying filter which does not meet the standard specifications from being coupled to the connection valve.

Although example embodiments of the disclosure have been shown and described, it would be appreciated by those skilled in the art that changes may be made to these embodiments without departing from the principles and spirit of the disclosure, the scope of which is defined in the claims and their equivalents.

What is claimed is:

1. A water purifying filter, comprising:
an inner housing to accommodate a filter therein; and
an outer housing to accommodate the inner housing therein, such that an outer surface of the inner housing and an inner surface of the outer housing are spaced apart from each other to form an insulation space.

2. The water purifying filter according to claim 1, wherein the insulation space is maintained in a vacuum state.

3. The water purifying filter according to claim 1, further comprising an insulator to fill the insulation space.

4. The water purifying filter according to claim 1, wherein
the inner housing has a hollow substantially cylindrical shape, and
the outer housing has a hollow substantially square container shape.

5. The water purifying filter according to claim 4, wherein
one side of the inner housing is open,
one side of the outer housing is open, and
the water purifying filter further includes a connection cap to cover the one side of the inner housing and the one side of the outer housing.

6. The water purifying filter according to claim 5, wherein the connection cap includes:
a cap portion to cover the one side of the inner housing and the one side of the outer housing;
an inner fixed portion which extends in a circular ring form from the cap portion and to which the one side of the inner housing is fixed; and
an outer fixed portion which extends in a square ring form from the cap portion and to which the one side of the outer housing is fixed.

7. A refrigerator, comprising:
a main body including an installation hole having a substantially square shape and a connection valve disposed in the installation hole; and
a water purifying filter having a substantially square container shape and configured to be installed in the installation hole by rotation of the water purifying filter so as to couple the water purifying filter to the connection valve, and to be detachable from the main body by rotation of the water purifying filter so as to de-couple the water purifying filter from the connection valve.

8. The refrigerator according to claim 7, wherein the water purifying filter includes an outer housing forming an exterior of the water purifying filter, the outer housing including:
a body portion having a substantially square container shape;
a lid portion having a substantially square shape at one side of the body portion and configured to cover the installation hole; and
a rotary guide portion disposed between the body portion and the lid portion and having a circular cross-section.

9. The refrigerator according to claim 8, wherein the outer housing further includes a knob portion disposed on the lid portion.

10. The refrigerator according to claim 8, wherein the water purifying filter further includes an inner housing configured to accommodate a filter and accommodated in the outer housing.

11. The refrigerator according to claim 8, wherein an outer surface of the inner housing and an inner surface of the outer housing are spaced apart from each other to form an insulation space.

12. The refrigerator according to claim 8, wherein
the water purifying filter further includes a connection cap configured to cover one side of the outer housing and coupled to the connection valve,
the connection cap includes coupling hooks coupled to the connection valve, and
the connection valve has a substantially cylindrical shape, one side of which is open, and includes coupling projections disposed on an inner circumferential surface of the connection valve and configured to interact with the coupling hooks for insertion of the water purifying filter into the installation hole.

13. The refrigerator according to claim 8, further comprising an installation guide device disposed in the installation hole and configured to guide the water purifying filter when the water purifying filter is inserted into the installation hole to be coupled with the connection valve.

14. The refrigerator according to claim 13, wherein the installation guide device includes:
a pressure lever configured to provide a downward pressurizing force to the water purifying filter installed in the installation hole; and
at least one guide member disposed below the water purifying filter to support corners of the outer housing.

15. The refrigerator according to claim 14, wherein the pressure lever includes:
a fixed portion fixed to the main body;
a pressurizing portion protruding in an insertion path of the water purifying filter; and
an elastic portion disposed between the fixed portion and the pressurizing portion to apply an elastic force to the water purifying filter.

16. The refrigerator according to claim 14, wherein the at least one guide member includes a pair of guide members spaced apart from each other in a horizontal direction.

17. The refrigerator according to claim 16, wherein
the installation guide device further includes a stopping member disposed between the pair of guide members, and
the stopping member includes a stopping projection configured to stop a front end of a non-conforming water purifying filter that does not satisfy predetermined specification requirements for installation in the installation hole, thereby limiting a penetration depth of the non-conforming water purifying filter into the installation hole.

18. The refrigerator according to claim 16, wherein the pair of guide members each include a guide plane having a curved shape and are configured to guide movement and rotation of the water purifying filter.

19. The refrigerator according to claim 18, wherein the guide plane has a radius of curvature corresponding to half a diagonal length of the outer housing.

20. The refrigerator according to claim 18, wherein the corners of the outer housing are curved.
